(19) United States
(12) Patent Application Publication
(10) Pub. No.: US 2026/0332823 A1
(43) Pub. Date: Oct. 22, 2026

(54) VIDEO ENCODER AND VIDEO DECODER

(71) Applicant: Telefonaktiebolaget LM Ericsson (publ), Stockholm (SE)

(72) Inventors: Martin PETTERSSON, Vallentuna (SE); Rickard SJÖBERG, Stockholm (SE)

(73) Assignee: Telefonaktiebolaget LM Ericsson (publ), Stockholm (SE)

(21) Appl. No.: 19/120,200

(22) PCT Filed: Oct. 13, 2023
(86) PCT No.: PCT/EP2023/078536

§ 371 Date: Apr. 10, 2025

Related U.S. Application Data
(60) Provisional application No. 63/415,719, filed on Oct. 13, 2022.

(51) Int. Cl. H04N 19/70; H04N 19/13; H04N 19/14; H04N 19/172; H04N 19/196; H04N 19/86

(52) U.S. Cl. CPC H04N 19/70; H04N 19/13; H04N 19/14; H04N 19/172; H04N 19/196; H04N 19/86

(57) ABSTRACT

A method for picture processing. The method includes deriving an indicator value (V) from one or more syntax elements in a bitstream (e.g., V may be decoded from a single indicator syntax element), where V was encoded into the bitstream using variable length coding. The method also includes determining whether V indicates that a first set of syntax elements is present in the bitstream, wherein the determining comprises: 1) calculating R1=(V & X) where & is a bitwise AND operator and 2) either 2a) determining whether R1 is equal to X or 2b) determining whether R1 is not equal to 0. The method further includes processing at least a first picture, wherein, if the first set of syntax elements is present in the bitstream, the first set of syntax elements are used in the processing of the first picture.

### TECHNICAL FIELD

Disclosed are embodiments related to video encoding and video decoding.

### BACKGROUND

### 1. Versatile Video Coding (VVC) and High Efficiency Video Coding (HEVC)

Versatile Video Coding (VVC) and its predecessor, High Efficiency Video Coding (HEVC), are block-based video codecs standardized and developed jointly by ITU-T and MPEG. The codecs utilize both temporal and spatial prediction. Spatial prediction is achieved using intra (I) prediction from within the current picture. Temporal prediction is achieved using uni-directional (P) or bi-directional inter (B) prediction on the block level from previously decoded reference pictures.

In the encoder, the difference between the original sample data and the predicted sample data, referred to as the residual, is transformed into the frequency domain, quantized, and then entropy coded before transmitted together with necessary prediction parameters such as prediction mode and motion vectors, also entropy coded. The decoder performs entropy decoding, inverse quantization, and inverse transformation to obtain the residual, and then adds the residual to an intra or inter prediction to reconstruct a picture.

The VVC version 1 specification was published as Rec. ITU-T H.266| ISO/IEC 23090-3, “Versatile Video Coding,” in 2020. MPEG and ITU-T are working together within the Joint Video Exploratory Team (JVET) on updated versions of HEVC and VVC as well as the successor to VVC, i.e., the next generation video codec.

### 2. Components

A video sequence consists of a series of pictures where each picture consists of one or more components. A picture in a video sequence is sometimes denoted ‘image’ or ‘frame’. Each component in a picture can be described as a two-dimensional rectangular array of picture sample values (or “sample values” or “samples” for short). It is common that a picture in a video sequence consists of three components; one luma component Y where the sample values are luma values and two chroma components Cb and Cr, where the sample values are chroma values. Other common representations include ICtCb, IPT, constant-luminance YCbCr, YCoCg and others. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as ‘color components’, and other times as ‘channels’.

### 3. Blocks and Units

In many video coding standards, such as HEVC and VVC, each component of a picture is split into blocks and the coded video bitstream consists of a series of coded blocks. A block is a two-dimensional array of samples. It is common in video coding that the picture is split into units that cover a specific area of the picture.

Each unit consists of all blocks from all components that make up that specific area and each block belongs fully to one unit. The macroblock in H.264 and the Coding Unit (CU) in HEVC and VVC are examples of units. In VVC the CUs may be split recursively to smaller CUs. The CU at the top level is referred to as the coding tree unit (CTU). A CU usually contains three coding blocks, i.e. one coding block for luma and two coding blocks for chroma. A block to which a transform used in coding is applied is referred to as a “transform block.” And a block to which a prediction mode is applied is referred to as a “prediction blocks.”

### 4. Network Abstraction Layer (NAL)

HEVC and VVC define a Network Abstraction Layer (NAL). A NAL unit is a data structure that contains data. A so-called Video Coding Layer (VCL) NAL unit contains data that represents picture sample values. A non-VCL NAL unit contains additional associated data such as parameter sets and supplemental enhancement information (SEI) messages. The NAL unit in HEVC begins with a 2-byte header which specifies the NAL unit type of the NAL unit that identifies what type of data is carried in the NAL unit, the layer ID and the temporal ID for which the NAL unit belongs to. The NAL unit type is transmitted in the nal_unit_type codeword in the NAL unit header and the type indicates and defines how the NAL unit should be parsed and decoded. The bytes after the 2-byte NAL unit header is payload of the type indicated by the NAL unit type. A bitstream consists of a series of concatenated NAL units

### 5. Slices and Tiles

The concept of slices in HEVC divides the picture into independently coded slices, where decoding of one slice in a picture is independent of other slices of the same picture. Different coding types could be used for slices of the same picture, i.e. a slice could either be an I-slice, P-slice or B-slice. One purpose of slices is to enable resynchronization in case of data loss. In HEVC, a slice is a set of CTUs.

The VVC and HEVC video coding standards includes a tool called tiles that divides a picture into rectangular spatially independent regions. Tiles in VVC are similar to the tiles used in HEVC. Using tiles, a picture in VVC can be partitioned into rows and columns of CTUs where a tile is an intersection of a row and a column.

In VVC, a slice is defined as an integer number of complete tiles or an integer number of consecutive complete CTU rows within a tile of a picture that are exclusively contained in a single NAL unit. In VVC, a picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit. In an early draft of the VVC specification, slices were referred to as tile groups.

### 6. Subpictures

Subpictures are supported in VVC where a subpicture is defined as a rectangular region of one or more slices within a picture. This means a subpicture contains one or more slices that collectively cover a rectangular region of a picture. In the VVC specification subpicture location and size are signaled in the SPS. Boundaries of a subpicture region may be treated as picture boundaries (excluding in-loop filtering operations) conditioned to a per-subpicture flag subpic_treated_as_pic_flag[i] in the SPS. Also loop-filtering on subpicture boundaries is conditioned to a per-subpicture flag loop_filter_across_subpic_enabled_flag[i] in the SPS. Bitstream extraction and merge operations are supported through subpictures in VVC and could for instance comprise extracting one or more subpictures from a first bitstream, extracting one or more subpictures from a second bitstream and merging the extracted subpictures into a new third bitstream.

### 7. Parameter Sets

HEVC and VVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs, e.g., data for multiple scalability layers in the bitstream.

VVC also specifies one additional parameter set, the adaptation parameter set (APS). The APS carries parameters needed for the adaptive loop filter (ALF) tool, the luma mapping and chroma scaling (LMCS) tool and the scaling list tool.

Both HEVC and VVC allow certain information (e.g., parameter sets) to be provided by external means. “By external means” should be interpreted as the information is not provided in the coded video bitstream but by some other means not specified in the video codec specification, e.g., via metadata possibly provided in a different data channel, as a constant in the decoder, or provided through an API to the decoder.

### 8. Picture Header

VVC includes a picture header syntax structure that contains syntax elements that are common for all slices of the associated picture. This syntax structure can either be conveyed in its own NAL unit or be included in a slice header when there is only one slice in the picture. When conveyed in a NAL unit, the NAL unit type is equal to a value that indicates that the NAL unit contains a picture header. The values of the syntax elements in the picture header are used to decode all slices of one picture.

### 9. Decoding Capability Information (DCI)

In VVC there is a DCI NAL unit. The DCI specifies information that doesn't change during the decoding session and may be good for the decoder to know about early and upfront, such as profile and level information. The information in the DCI is not necessary for operation of the decoding process. In drafts of the VVC specification the DCI was called decoding parameter set (DPS).

The decoding capability information may also contain a set of general constraints for the bitstream, that gives the decoder information of what to expect from the bitstream, in terms of coding tools, types of NAL units, etc. In VVC version 1, the general constraint information can be signaled in the DCI, VPS or SPS.

### 10. SEI Messages

Supplementary Enhancement Information (SEI) messages are codepoints in the coded bitstream that do not influence the decoding process of coded pictures from VCL NAL units. SEI messages usually address issues of representation/rendering of the decoded bitstream. The overall concept of SEI messages and many of the SEI messages themselves have been inherited from the H.264 and HEVC specifications into the VVC specification. In VVC, an SEI RBSP contains one or more SEI messages.

SEI messages assist in processes related to decoding, display or other purposes. However, SEI messages are not required for constructing the luma or chroma samples by the decoding process. Some SEI messages are required for checking bitstream conformance and for output timing decoder conformance. Other SEI messages are not required for checking bitstream conformance. A decoder is not required to support all SEI messages. Usually, if a decoder encounters an unsupported SEI message, then the decoder discards the SEI message.

ITU-T H.274|ISO/IEC 23002-7, also referred to as VSEI, specifies the syntax and semantics of SEI messages and is particularly intended for use with VVC, although it is written in a manner intended to be sufficiently generic that it may also be used with other types of coded video bitstreams. The first version of ITU-T H.274| ISO/IEC 23002-7 was finalized in July 2020. At the time of writing, version 3 is under development, and the most recent draft is JVET-AA2006-v2.

### 11. Postfilters

A postfilter is a filter that can be applied to a picture before the picture is displayed or otherwise further processed. A postfilter does not affect the contents of the decoded picture buffer (DPB), i.e., it does not affect the samples that future pictures are predicted from. Instead, it takes samples from the picture buffer and filters them before they are displayed or further processed. As an example, such further processing can involve scaling the picture to allow the picture to be rendered in a full-screen mode, reencoding the picture (this is known to a person skilled in the art as ‘transcoding’), using machine vision algorithms to extract information from the picture, etc. Since a postfilter does not affect the prediction, doing postfilters a bit differently in every decoder does not give rise to drift. Hence it is often not necessary to standardize postfilters. In some codecs, the postfilter may be considered to be part of the decoder, and the samples output from the decoder are the samples output from the postfilter. In other codecs, the postfilter may be considered to be outside the decoder, and the samples output from the decoder are the samples that are inputted to the postfilter. In this disclosure both cases are covered.

### 12. Neural Networks for Image and Video Compression

A neural network (NN) consists of multiple layers of simple processing units called neurons or nodes which interact with each other via weighted connections and collectively create a powerful tool in the context of non-linear transforms and classification. Each node gets activated through weighted connections from previously activated nodes. To achieve non-linearity, a non-linear activation function is applied to the intermediate layers. A neural network architecture usually consists of an input layer, an output layer and one or more intermediate layers, each of which contains various number of nodes.

Neural-network-based techniques for image and video coding and compression have been explored, particularly after introduction of convolutional neural networks (CNNs), which provide a reasonable trade-off between the number of the neural network model parameters and trainability of the neural network model. CNNs have a smaller number of parameters compared to fully connected neural networks which makes the large-scale neural network training possible.

### 13. Fixed Length Coding, Variable Length Coding and Universal Coding

In coding theory, a fixed-length code is a code which maps source symbols, e.g. integers, to a fixed number of bits, i.e., all source symbols are coded using the same number of bits. For instance, the values 0 to 7 may be coded using three bits with the following codewords; 000, 001, 010, 011, 100, 101, 110 and 111.

A variable-length code (VLC), on the other hand, is a code which maps source symbols to a variable number of bits. A common strategy for variable-length coding is to rely on probabilities, such that a source symbol with a higher probability is coded with a shorter codeword than for a source symbol having a lower probability. Some examples of well-known variable-length coding strategies are Huffman coding, Lempel-Ziv coding, arithmetic coding, and context-adaptive variable-length coding.

A universal code for positive integers maps the positive integers onto binary codewords, with the additional property that whatever the true probability distribution on integers, as long as the distribution is monotonic (i.e., p(i)≥p(i+1) for all positive i), the expected lengths of the codewords are within a constant factor of the expected lengths that the optimal code for that probability distribution would have assigned. A coding scheme that uses both variable-length coding and universal coding is called universal variable-length coding (UVLC). The Exp-Golomb coding that is used in HEVC and VVC for coding integer source symbols is an example of a UVLC scheme.

14. Syntax functions and descriptors

All of HEVC, VVC and VSEI uses specific syntax functions and descriptors to specify what type of data that is written to the bitstream for each syntax element. The following text is taken from VSEI and describes the different descriptors that are used in VSEI. Similar descriptors are used in HEVC and VVC.

The functions presented in this clause are used in the syntactical description. These functions are expressed in terms of the value of the VUI parameters syntax or an SEI message syntax data pointer that indicates the position of the next bit to be read by the decoding process from the syntax structure.

The function read_bits(n) reads the next n bits from the syntax structure and advances the data pointer by n bit positions. When n is equal to 0, read_bits(n) is specified to return a value equal to 0 and to not advance the data pointer.

The following descriptors specify the parsing process of each syntax element:

b(8): byte having any pattern of bit string (8 bits). The parsing process for this descriptor is specified by the return value of the function read_bits(8).

f(n): fixed-pattern bit string using n bits written (from left to right) with the left bit first. The parsing process for this descriptor is specified by the return value of the function read_bits(n).

i(n): signed integer using n bits. When n is “v” in the syntax table, the number of bits varies in a manner dependent on the value of other syntax elements. The parsing process for this descriptor is specified by the return value of the function read_bits(n) interpreted as a two's complement integer representation with most significant bit written first.

se(v): signed integer 0-th order Exp-Golomb-coded syntax element with the left bit first. The parsing process for this descriptor is specified below with the order k equal to 0.

st(v): null-terminated string encoded as universal coded character set (UCS) transmission format-8 (UTF-8) characters as specified in ISO/IEC 10646. The parsing process is specified as follows: st(v) begins at a byte-aligned position in the bitstream and reads and returns a series of bytes from the bitstream, beginning at the current position and continuing up to but not including the next byte-aligned byte that is equal to 0x00, and advances the bitstream pointer by (stringLength+1)*8 bit positions, where stringLength is equal to the number of bytes returned. The st(v) syntax descriptor is only used in this Specification when the current position in the bitstream is a byte-aligned position.

u(n): unsigned integer using n bits. When n is “v” in the syntax table, the number of bits varies in a manner dependent on the value of other syntax elements. The parsing process for this descriptor is specified by the return value of the function read_bits(n) interpreted as a binary representation of an unsigned integer with most significant bit written first.

ue(v): unsigned integer 0-th order Exp-Golomb-coded syntax element with the left bit first. The parsing process for this descriptor is described below with order k equal to 0.

14.1 Parsing process

Syntax elements coded as ue(v) or se(v) are Exp-Golomb-coded with order k equal to 0. The parsing process for these syntax elements begins with reading the bits starting at the current location in the bitstream up to and including the first non-zero bit, and counting the number of leading bits that are equal to 0. This process is specified as follows:
leadingZeroBits=−1;
for(b=0; !b; leadingZeroBits++){b=read_bits(1)}.

The variable codeNum is then assigned as follows:

codeNum=(2^{leadingZeroBits}−1)*2^{k}+read_bits(leadingZeroBits+k)

where the value returned from read_bits(leadingZeroBits) is interpreted as a binary representation of an unsigned integer with most significant bit written first.

Table 1 below illustrates the structure of the 0-th order Exp-Golomb code by separating the bit string into “prefix” and “suffix” bits. The “prefix” bits are those bits that are parsed for the computation of leadingZeroBits, and are shown as either 0 or 1 in the bit string column of Table 1. The “suffix” bits are those bits that are parsed in the computation of codeNum and are shown as xi in the table, with i in the range of 0 to leadingZeroBits−1, inclusive. Each xi is equal to either 0 or 1.

TABLE 1
Bit strings with “prefix” and “suffix”
bits and assignment to codeNum ranges

| Bit string form | Range of codeNum |
|---|---|
| 1 | 0 |
| 0 1 x₀ | 1 . . . 2 |
| 0 0 1 x₁ x₀ | 3 . . . 6 |
| 0 0 0 1 x₂ x₁ x₀ | 7 . . . 14 |
| 0 0 0 0 1 x₃ x₂ x₁ x₀ | 15 . . . 30 |
| 0 0 0 0 0 1 x₄ x₃ x₂ x₁ x₀ | 31 . . . 62 |
| . . . | . . . |

### 15. Indicators and Flags in Video Coding

Indicators in the form of integer values and binary flags are commonly used in video coding to indicate whether sets of syntax elements are present in the bitstream or not. The example below shown in Table 2 shows a typical usage where the indicator is an integer syntax element that can take on four possible values, 0, 1, 2, and 3. Foreach of the possible values, a conditional check is made to see if the indicator value is equal to that value, and if so a corresponding set of syntax elements are present in the bitstream. E.g., if the indicator value is equal to 0, then only the syntax elements syntax_elemnt_A1, . . . , syntax_element_AN are present in the bitstream, otherwise if the indicatorvalue is equal to 1, then only the syntax elements syntax_element_B1, . . . , syntax_element_BN, are present in the bitstream, etc. These syntax elements are referred to as syntax element sets A, B, C and D.

TABLE 2

| | Descriptor |
|---|---|
| ... | |
| indicator | u(2) |
| if( indicator == 0 ) { | |
| syntax_{—}element_{—}A1 | u(n) |
| ... | |
| syntax_{—}element_{—}AN | u(n) |
| } | |
| else if( indicator == 1 ) { | |
| syntax_{—}element_{—}B1 | u(n) |
| ... | |
| syntax_{—}element_{—}BN | u(n) |
| } | |
| else if( indicator == 2 ) { | |
| syntax_{—}element_{—}C1 | u(n) |
| ... | |
| syntax_{—}element_{—}CN | u(n) |
| } | |
| else if( indicator == 3 ) { | |
| syntax_{—}element_{—}D1 | u(n) |
| ... | |
| syntax_{—}element_{—}DN | u(n) |
| } | |
| } | |

With this notation of conditional checks using if-statements it is not possible P to decode multiple sets of syntax elements at the same time, e.g. both syntax_element set A and syntax element set B, without having to add an additional conditional check for the indicator, e.g. else if(indicator==4), for which both of the syntax element sets A and B are present in the bitstream. That however, would require the syntax elements to be repeated in the syntax table, and is not a particularly good solution, especially if there are many combinations. Another option would be to use an or-operator (∥) in the if-statement, which in the example above would be like as shown in Table 3.

TABLE 3

```
if ( indicator == 0 || indicator == 4 )
  decode set A
if ( indicator == 1 || indicator == 4 )
  decode set B
    ...
```

However, a problem with that is that it is not future-proof if new syntax element sets are added in a future extension/profile.

A common practice in video codec specifications is otherwise to use a flag for indicating whether a set of syntax elements are present in the bitstream or not. For instance, in the example syntax table shown below in Table 4, four flags are first decoded, flag_A, flag_B, flag_C and flag_D, wherein each flag specifies whether a set of syntax elements A, B, C or D are present in the bitstream or not.

TABLE 4

| | Descriptor |
|---|---|
| ... | |
| flag_{—}A | u(1) |
| flag_{—}B | u(1) |
| flag_{—}C | u(1) |
| flag_{—}D | u(1) |
| if( flag_{—}A ) { | |
| syntax_{—}element_{—}A | u(n) |
| ... | |
| } | |
| if( flag_{—}B ) { | |
| syntax_{—}element_{—}B | u(n) |
| ... | |
| } | |
| if( flag_{—}C ) { | |
| syntax_{—}element_{—}C | u(n) |
| ... | |
| } | |
| if( flag_{—}D ) { | |
| syntax_{—}element_{—}D | u(n) |
| ... | |
| } | |
| ... | |
| } | |

16. Neural Network-Based Postfilter Indicated with SEI Message

The current draft of version 3 of ITU-T H.274|ISO/IEC 23002-7, also referred to as VSEI, comprises a NN post-filter characteristics SEI message, containing an NN postfilter signaled using the MPEG Neural Network Representation (NNR, ISO/EC 15938-17) standard, alternatively references a URL where the parameters for the NN post-filter can be fetched.

Syntax and relevant semantics for the SEI message from the version 3 draft of VSEI in JVET-AA2006v2, is shown below in Table 5.

TABLE 5
Neural-network post-filter characteristics SEI message

| | Descriptor |
|---|---|
| nn_post_filter_characteristics( payloadSize ) { | |
| nnpfc_{—}id | ue(v) |
| nnpfc_{—}mode_{—}idc | ue(v) |
| nnpfc_{—}purpose_{—}and_{—}formatting_{—}flag | u(1) |
| if( nnpfc_purpose_and_formatting_flag ) { | |
| ... | |
| nnpfc_{—}complexity_{—}idc | ue(v) |
| if( nnpfc_complexity_idc > 0 ) | |
| nnpfc_complexity_element( nnpfc_complexity_idc ) | |
| if( nnpfc_mode_idc = = 2 ) { | |
| while( !byte_aligned( ) ) | |
| nnpfc_{—}reserved_{—}zero_{—}bit | u(1) |
| nnpfc_{—}uri_{—}tag[ i ] | st(v) |
| nnpfc_{—}uri[ i ] | st(v) |
| } | |
| } | |
| /* filter specified or updated by | |
| ISO/IEC 15938-17 bitstream */ | |
| if( nnpfc_mode_idc = = 1 ) { | |
| while( !byte_aligned( ) ) | |
| nnpfc_{—}reserved_{—}zero_{—}bit | u(1) |
| for( i = 0; more_data_in_payload( ); i++ ) | |
| nnpfc_{—}payload_{—}byte[ i ] | b(8) |
| } | |
| } | |
| nnpfc_complexity_element( nnpfc_complexity_idc ) { | |
| if( nnpfc_complexity_idc = = 1 ) { | |
| nnpfc_{—}parameter_{—}type_{—}idc | u(2) |
| if (nnpfc_parameter_type_idc ! = 2) | |
| nnpfc_{—}log2_{—}parameter_{—}bit_{—}length_{—}minus3 | u(2) |
| nnpfc_{—}num_{—}parameters_{—}idc | u(6) |
| nnpfc_{—}num_{—}kmac_{—}operations_{—}idc | ue(v) |
| } | |
| } | |

nnpfc_id contains an identifying number that may be used to identify a post-processing filter. The value of nnpfc_id shall be in the range of 0 to 2³²−2, inclusive. Values of nnpfc_id from 256 to 511, inclusive, and from 2³¹ to 2³²−2, inclusive, are reserved for future use by ITU-T|ISO/IEC. Decoders encountering a value of nnpfc_id in the range of 256 to 511, inclusive, or in the range of 2³¹ to 2³²−2, inclusive, shall ignore it.

nnpfc_mode_idc equal to 0 specifies that the post-processing filter associated with the nnpfc_id value is determined by external means not specified in this Specification.

nnpfc_mode_idc equal to 1 specifies that the post-processing filter associated with the nnpfc_id value is a neural network represented by the ISO/IEC 15938-17 bitstream contained in this SEI message.

nnpfc_mode_idc equal to 2 specifies that the post-processing filter associated with the nnpfc_id value is a neural network identified by a specified tag Uniform Resource Identifier (URI) (nnpfc_uri_tag[i]) and neural network information URI (nnpfc_uri[i]). The value of nnpfc_mode_idc shall be in the range of 0 to 255, inclusive. Values of nnpfc_mode_idc greater than 2 are reserved for future specification by ITU-T|ISO/IEC and shall not be present in bitstreams conforming to this version of this Specification. Decoders conforming to this version of this Specification shall ignore SEI messages that contain reserved values of nnpfc_mode_idc.

nnpfc_complexity_idc greater than 0 specifies that one or more syntax elements that indicate the complexity of the post-processing filter associated with the nnpfc_id may be present. nnpfc_complexity_idc equal to 0 specifies that no syntax elements is that indicate the complexity of the post-processing filter associated with the nnpfc_id are present. The value nnpfc_complexity_idc shall be in the range of 0 to 255, inclusive. Values of nnpfc_complexity_idc greater than 1 are reserved for future specification by ITU-T|ISO/IEC and shall not be present in bitstreams conforming to this version of this Specification. Decoders conforming to this version of this Specification shall ignore SEI messages that contain reserved values of nnpfc_complexity_idc.

### 17. Decoded Picture Buffer (DPB)

Decoded pictures are stored by the decoder so that they can be used for temporal prediction when decoding future pictures. Those pictures are commonly stored in a decoded picture buffer (DPB). The DPB conceptually consists of a limited number of picture buffers where each picture buffer holds all sample data and motion vector data that may be needed for decoding of future pictures. In HEVC, sample data is needed for motion compensation and motion vector data is needed for temporal motion vector prediction (TMVP). Each picture in the DPB is marked as either “used for short-term reference”, “used for long-term reference”, or “unused for reference”. A picture is stored in the DPB either because it may be used for prediction during decoding or because it is waiting for output. The DPB has a limited size that limits the amount of memory the decoder needs to allocate as well as the number of reference pictures an encoder may use. The memory size is specified by a bitstream level that can be indicated in the bitstream or signaled by the system. A decoder is typically claiming conformance to a specific level which means that it is capable of decoding all bitstreams conforming to that level and lower levels. The decoder may allocate the maximum number of bytes specified by the level and be certain that all bitstreams of that level and lower are decodable.

### SUMMARY

Certain challenges presently exist. For instance, a problem with existing solutions for video coding, where an indicator value is used to specify whether a set of syntax elements are present in the bitstream or not, is that it does not appear to be possible to indicate that more than one set of syntax elements are present in the bitstream at a time unless more conditional checks are made, or multiple indicators, e.g. binary flags, are used where each flag indicates whether a specific set of syntax elements is present in the bitstream or not. The flexibility of sending a flag to indicate whether a set of syntax elements are present in the bitstream or not, however, comes at a cost in compression efficiency.

For example, a specific problem can be seen with the nnpfc_complexity_idc syntax element which is used to signal a set of syntax elements indicating the complexity of the NN postfilter sent in the NN postfilter characteristics SEI message. When this syntax element is equal to 1, a first set of syntax elements is present in the SEI message. Values higher than 1 are reserved for future specification, meaning that extensions can be made to the syntax at updated versions of the specification. This would likely entail sending alternative syntax elements for indicating complexity. However, using a new value of nnpfc_complexity_idc, e.g. “if(nnpfc_complexity_idc==2)”, to send a new second set of syntax elements would mean that the first set of syntax elements is not sent. Here one would want the option to receive both the first and second sets of syntax elements. Sending the SEI message twice with different values of nnpfc_complexity_idc would not a good option because it adds redundant overhead and the usage of the SEI message may become confusing. Moreover, the flag_A, flag_B solution wouldn't work here since the nnpfc_complexity_idc syntax element is not a flag and new flags can't be present in an extension when nnpfc_complexity_idc is equal to 0.

Accordingly, in one aspect there is provided a method for picture processing. The method includes deriving an indicator value (V), from one or more syntax elements in a bitstream (e.g., V may be decoded from a single indicator syntax element), where V was encoded into the bitstream using variable length coding. The method also includes determining whether V indicates that a first set of syntax elements is present in the bitstream, wherein the determining comprises: 1) calculating R1=(V & X) where & is a bitwise AND operator and 2) either 2a) determining whether R1 is equal to X or 2b) determining whether R1 is not equal to 0. The method further includes processing at least a first picture, wherein, if the first set of syntax elements is present in the bitstream, the first set of syntax elements are used in the processing of the first picture.

In another aspect there is provided a method for creating a video bitstream. The method includes deciding to encode in the bitstream a first set of values, wherein the first set of values is associated with a first value (X). The method also includes deciding to encode in the bitstream a second set of values, wherein the second set of values is associated with a second value (Y). The method also includes generating an indicator value. The method also includes adding to the bitstream one or more syntax elements (e.g., a single indicator syntax element) containing a coded version of the indicator value, wherein the indicator value was encoded using variable length coding. The method also includes adding to the bitstream a first set of syntax elements corresponding to the first set of values. The method further includes adding to the bitstream a second set of syntax elements corresponding to the second set of values. Generating the indicator value comprises generating the indicator value such that: (V & X) is equal to X, where V is the indicator value, and (V & Y) is equal to Y.

In some aspects, there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of embodiments disclosed herein is that they enable determining, based on a single indicator value, whether one or more sets of syntax elements are present in the bitstream or not. This saves bits and increases the video compression efficiency. Another advantage of the embodiments is that the embodiments are easily extended for updated versions of a video coding specification, to account for additional indications whether new sets of syntax elements are present in the bitstream or not.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of an encoder according to an embodiment.

FIG. 3 is a schematic block diagram of a decoder according to an embodiment.

FIG. 4 is a flowchart illustrating a process according to an embodiment.

FIG. 5 is a flowchart illustrating a process according to an embodiment.

FIG. 6 is a flowchart illustrating a process according to an embodiment.

FIG. 7 is a block diagram of an encoding apparatus according to an embodiment.

### DETAILED DESCRIPTION

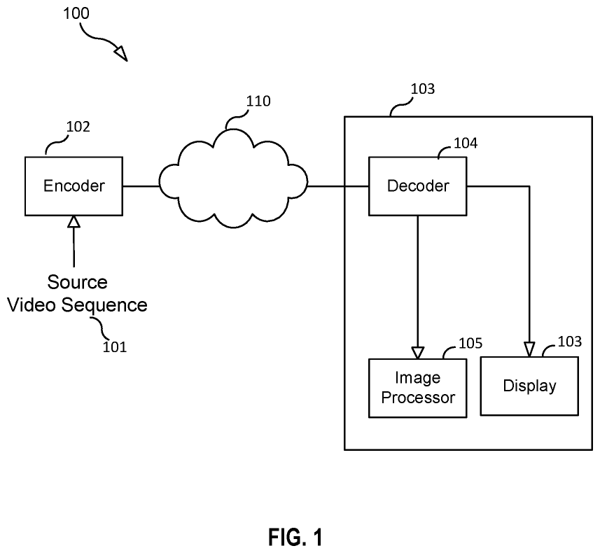

FIG. 1 illustrates a system 100 according to an embodiment. System 100 includes an encoder 102 and a decoder 104, wherein encoder 102 is in communication with decoder 104 via a network 110 (e.g., the Internet or other network). Encoder 102 encodes a source video sequence 101 into a bitstream comprising an encoded video sequence and transmits the bitstream to decoder 104 via network 110. In some embodiments, encoder 102 is not in communication with decoder 104, and, in such an embodiment, rather than transmitting bitstream to decoder 104, the bitstream is stored in a data storage unit. Decoder 104 decodes the coded pictures included in the encoded video sequence to produce video data for display and/or further image processing (e.g. a machine vision task). Accordingly, decoder 104 may be part of a device 103 having an image processor 105 (a.k.a., post-filter) and/or a display 106. The image processor 105 may perform machine vision tasks on the decoded pictures. One such machine vision task may be identifying objects in the picture. The image processor 105 may also perform image enhancements on the decoded picture. The image processor 105 may use a neural network-based algorithm for the image enhancements. The device 103 may be a mobile device, a set-top device, a head-mounted display, or any other device.

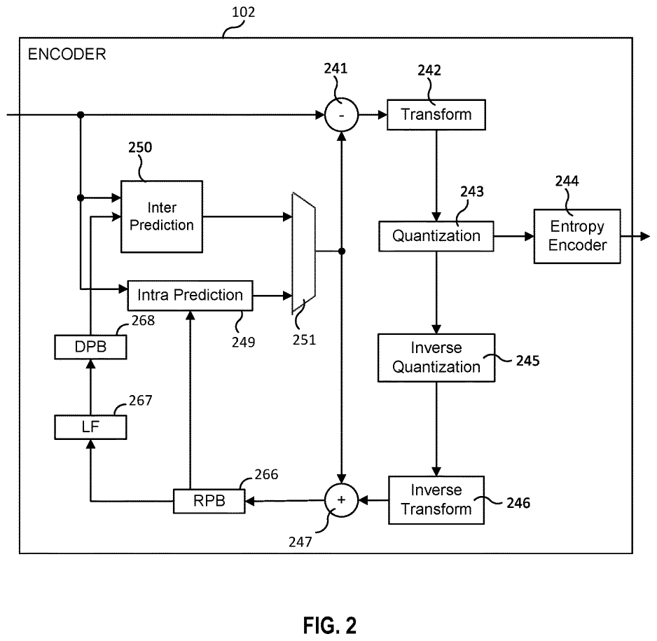

FIG. 2 illustrates functional components of encoder 102 according to some embodiments. It should be noted that encoders may be implemented differently so implementation other than this specific example can be used. Encoder 102 employs a subtractor 241 to produce a residual block which is the difference in sample values between an input block and a prediction block (i.e., the output of a selector 251, which is either an inter prediction block output by an inter predictor 250 (a.k.a., motion compensator) or an intra prediction block output by an intra predictor 249). Then a forward transform 242 is performed on the residual block to produce a transformed block comprising transform coefficients. A quantization unit 243 quantizes the transform coefficients based on a quantization parameter (QP) value (e.g., a QP value obtained based on a picture QP value for the picture in which the input block is a part and a block specific QP offset value for the input block), thereby producing quantized transform coefficients which are then encoded into the bitstream by encoder 244 (e.g., an entropy encoder) and the bitstream with the encoded transform coefficients is output from encoder 102. Next, encoder 102 uses the quantized transform coefficients to produce a reconstructed block. This is done by first applying inverse quantization 245 and inverse transform 246 to the transform coefficients to produce a reconstructed residual block and using an adder 247 to add the prediction block to the reconstructed residual block, thereby producing the reconstructed block, which is stored in the reconstruction picture buffer (RPB) 266. Loop filtering by a loop filter (LF) stage 267 is applied and the final decoded picture is stored in a decoded picture buffer (DPB) 268, where it can then be used by the inter predictor 250 to produce an inter prediction block for the next picture to be processed. LF stage 267 may include three sub-stages: i) a deblocking filter, ii) a sample adaptive offset (SAO) filter, and iii) an Adaptive Loop Filter (ALF).

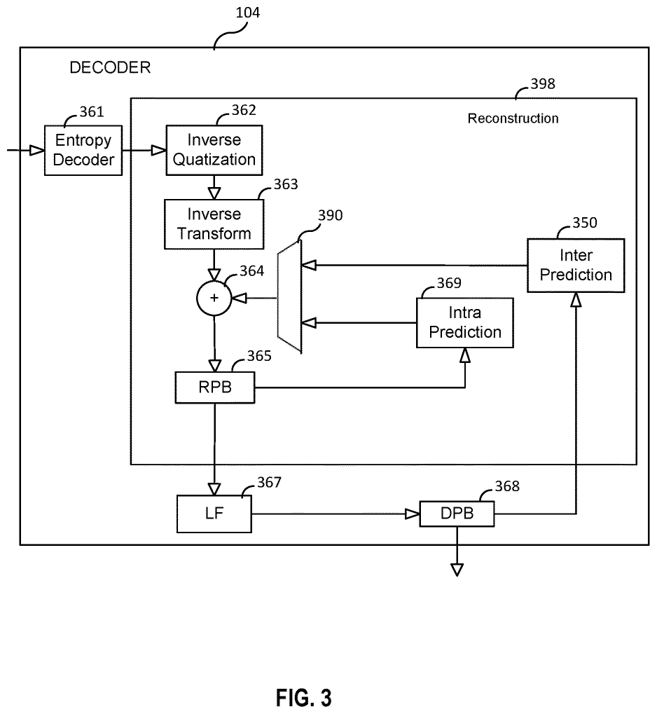

FIG. 3 illustrates functional components of decoder 104 according to some embodiments. It should be noted that decoder 104 may be implemented differently so implementations other than this specific example can be used. Decoder 104 includes a decoder module 361 (e.g., an entropy decoder) that decodes from the bitstream quantized transform coefficient values of a block. Decoder 104 also includes a reconstruction stage 398 in which the quantized transform coefficient values are subject to an inverse quantization process 362 and inverse transform process 363 to produce a residual block. This residual block is input to adder 364 that adds the residual block and a prediction block output from selector 390 to form a reconstructed block. Selector 390 either selects to output an inter prediction block or an intra prediction block. The reconstructed block is stored in a RPB 365. The inter prediction block is generated by the inter prediction module 350 and the intra prediction block is generated by the intra prediction module 369. Following the reconstruction stage 398, a loop filter stage 367 applies loop filtering and the final decoded picture may be stored in a decoded picture buffer (DPB) 368 and output to image processor 105. Pictures are stored in the DPB for two primary reasons: 1) to wait for picture output and 2) to be used for reference when decoding future pictures.

As described above, a challenge presently exists because conventional indicator techniques for indicating whether one or more sets of syntax elements are present in a bitstream are not efficient (i.e., require significant overhead). For example, assume that is possible for a bit stream to contain eight different sets of syntax elements and that the flag technique is used to signal whether a given one of the eight sets of syntax elements is present. With this assumption, eight bits are always needed, one for each set of syntax elements.

Accordingly, this disclosure provides a method for signaling an indicator value in the bitstream, where the indicator value is used to determine whether one or more sets of syntax elements are present in the bitstream or not, and the indicator value is encoded using variable length coding. Efficiencies can be achieved using variable length coding because fewer bits are needed to signal whether common combinations of sets of syntax elements are present in the bitstream or not compared with if all combinations would be equally probable.

A binary representation of the indicator value indicates, for each set of syntax elements, whether the set of syntax elements is present in the bitstream or not. In one embodiment, each bit in the binary representation of the indicator value determines whether a specific set of syntax elements is present in the bitstream or not. For example, if a particular bit is equal to 1, then the specific set of syntax elements associated with that particular bit is present in the bitstream, otherwise, if the bit is equal to 0 the specific set of syntax elements is not present in the bitstream. Note that a bit in the binary representation of the indicator value is not a bit of the coded indicator value that is in the bitstream.

In one embodiment, the indicator value is decoded from one syntax element, wherein the indicator value has been encoded using variable length coding.

In another embodiment, the indicator value is derived from two or more syntax elements in the bitstream. In the case of two or more syntax elements, at least one of the syntax elements has been encoded using variable length coding. In one embodiment, the indicator value has been encoded using universal coding (i.e., the indicator value has been encoded using UVLC). Exp-Golumb coding used in VVC is an example of UVLC.

By using variable length coding, more common combinations of indications of whether a set of syntax elements are present in the bitstream or not can be expressed using fewer bits than if all combinations would be equally probable, such as when using a flag for each of indication whether a set of syntax elements is present in the bitstream or not. In that case, one bit is needed to signal the flag for each indication whether a set of syntax elements is present in the bitstream or not.

The indicator value indicates for each set of syntax elements in a list of multiple sets of syntax elements, whether the set of syntax elements is present in the bitstream or not. In one embodiment, each bit in the binary representation of the indicator is value indicates whether a specific set of syntax elements that is associated with the bit is present in the bitstream or not. For example, if the bit is equal to 1, the set of syntax elements associated with the bit is indicated to be present in the bitstream (in this case, unless the encoder is faulty or there is an error in transmission or storage of the bitstream, the set of syntax elements associated with the bit should be present in the bitstream), otherwise, if the bit is equal to 0, the set of syntax elements associated with the bit is indicated as not present in the bitstream (in this case, unless the encoder is faulty or there is an error in transmission or storage of the bitstream, the set of syntax elements associated with the bit should not be present in the bitstream).

In decimal form, each bit in the binary form of the indicator value can be expressed with a decimal number from the set F={2ⁿ|n is an integer, n≥0}, i.e., F={1,2,4,8,16, . . . }, where each number corresponds to a bit position in the binary representation of the indicator value.

For instance, assume eight different sets of syntax elements may be encoded in the bitstream. With this assumption each set is represented by a unique decimal number from the following set: 2⁰=1, 2¹=2, 2²=4, 2³=8, 2⁴=16, 2⁵=32, 2⁶=64 and 2⁷=128. The indicator value then comprises the sum of all numbers corresponding to the sets of syntax elements that are present in the bitstream. For instance, if the second and fifth set of syntax elements are the only sets (of the eight different sets) present in the bitstream, the indicator value has the value of 18 in decimal form (i.e., 2¹+2⁴=18), which written in binary form is: 00010010. A binary bitwise OR (|) operator would also work, e.g. 2¹|2⁴=18₁₀.

In determining whether a set of syntax elements is present or not in the bitstream a conditional check on the indicator value (denoted “V”) could then be done with an “&” operator, a.k.a. binary bitwise “AND” operator. For instance, in checking if the third set of syntax elements is present in the bitstream or not, the following conditional check could be made “if ((V & 4)==4)”.

In a more generalized form, when (V & X) is equal to X, with X=2\hat{ }A, where A is a non-negative integer, e.g., A=0, X=1, a first set of syntax elements is indicated as being present in the bitstream. When (V & Y) is equal to Y, with Y=2\hat{ }B, where B is a non-negative integer not equal to A, e.g., B=1, Y=2, a second set of syntax elements is indicated as being present in the bitstream. In another form, when (V & X) is not equal to 0, with X=2\hat{ }A, where A is a non-negative integer, e.g., A=0, X=1, a first set of syntax elements is indicated as being present in the bitstream. When (V & Y) is not equal to 0, with Y=2\hat{ }B, where B is a non-negative integer not equal to A, e.g., B=1, Y=2, a second set of syntax elements is indicated as being present in the bitstream.

Assuming one or both of the first and second set of syntax elements are in the bitstream, then one or both of the first and second set of syntax elements are then used to process at least a one picture. Processing the picture may comprise decoding the picture and/or post-filtering the decoded picture.

From the generalized form above, there are at least three special cases worth mentioning. If the indicator value is equal to X, the first set of syntax elements is indicated as present in the bitstream, but not the second set of syntax elements and thus only the first set of syntax elements are used to process the picture. If the indicator value is equal to Y, the second set of syntax elements is indicated as present in the bitstream, but not the first set of syntax elements and thus only the second set of syntax elements are used to process the picture. If the indicator value is equal to X+Y (alternatively, if the indicator value is equal to X|Y), both the first and second sets of syntax elements are indicated as being present and decoded from the bitstream, and both the first and second set of syntax elements are used to process the picture.

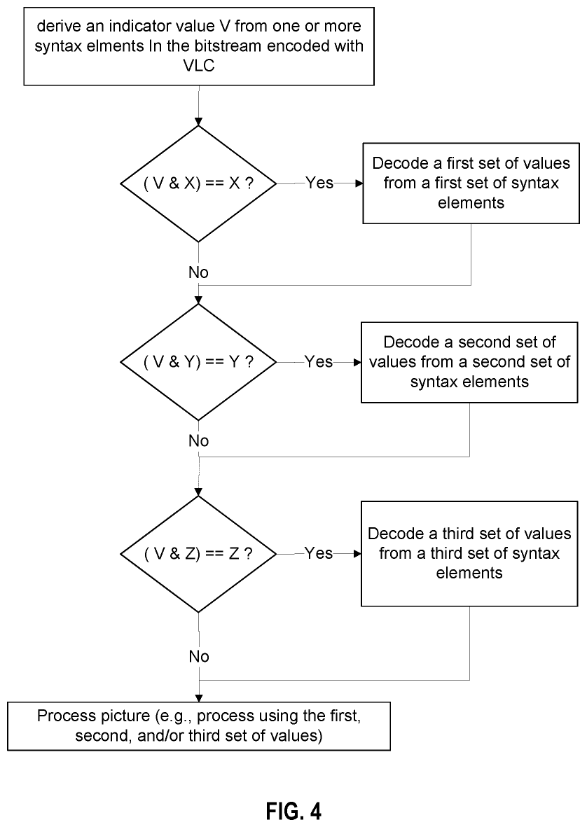

Example syntax is provided below. A decoder performs the following steps when decoding the bitstream. First, an indicator value V (a.k.a., “indicator”) is decoded from an indicator syntax element in the bitstream. If the first bit in the indicator value is set (i.e., (V & 1)==1), a first set of syntax elements, syntax_element_A1, . . . , syntax_element_AN is determined to be present in the bitstream (N being greater than or equal to 1). If the second bit in the indicator value is set (i.e., (V & 2)==2), a second set of syntax elements, syntax_element_B1, . . . , syntax_element_BN is determined to be present in the bitstream. If the third bit in the indicator value is set (i.e., (V & 4)==4), a third set of syntax elements, syntax_element_C1, . . . , syntax_element_CN, is determined to be present in the bitstream. If the fourth bit in the indicator value is set (i.e., (V & 8)==8), a fourth set of syntax elements, syntax_element_D1, . . . , syntax_element_DN, is determined to be present in the bitstream. If the fifth bit in the indicator value is set (i.e., (V & 16)==16), a fifth set of syntax elements, syntax_element_E1, . . . , syntax_element_EN, is determined to be present in the bitstream. More generally, if the ith bit of the indicator value is set (i.e., (V & 2⁽ⁱ⁻¹⁾)==2⁽ⁱ⁻¹⁾), an ith set of syntax elements is determined to be present in the bitstream. Alternatively, when (V & 2(ⁱ⁻¹⁾)!=0), an ith set of syntax elements is determined to be present in the bitstream. The syntax elements in the set of syntax elements are in the example below signaled using the u(n) descriptor, but any type of descriptor would be possible. FIG. 4 is a flowchart illustrating the above process.

Note that in the example, a bitstream where only the first or second set of syntax elements are present in the bitstream, would only need to use three bits at most, since 1 and 2 in Exp-Golumb code is represented with three bits.

TABLE 6

| | Descriptor |
|---|---|
| ... | |
| V // the indicator value | ue(v) |
| if( (V & 1 ) == 1 ) { | |
| syntax_{—}element_{—}A1 | u(n) |
| ... | |
| syntax_{—}element_{—}AN | u(n) |
| } | |
| if( (V & 2 ) == 2 ) { | |
| syntax_{—}element_{—}B1 | u(n) |
| ... | |
| syntax_{—}element_{—}BN | u(n) |
| } | |
| if( (V & 4 ) == 4 ) { | |
| syntax_{—}element_{—}C1 | u(n) |
| ... | |
| syntax_{—}element_{—}CN | u(n) |
| } | |
| if( (V & 8 ) == 8 ) { | |
| syntax_{—}element_{—}D1 | u(n) |
| ... | |
| syntax_{—}element_{—}DN | u(n) |
| } | |
| if( (V & 16 ) == 16 ) { | |
| syntax_{—}element_{—}E1 | u(n) |
| ... | |
| syntax_{—}element_{—}EN | u(n) |
| } | |
| ... | |

The five if-statements of the form “if((V & k)==k)” in TABLE 6 could be rephrased wherein they are written as one of “if((V & k)!=0)” or “if(V & k)”. In one embodiment, a first video codec specification specifies a first list of syntax element sets, wherein each syntax element set in the first list may or may not be present in the bitstream (hence, the indicator value functions to inform the decoder which of the syntax element sets are in the bitstream). In the example above, the first list of syntax element sets could for instance include: 1) a first set of syntax elements (i.e., syntax-element_A1, . . . syntax_element_AN), 2) a second set of syntax elements (i.e., syntax_element_B1, . . . syntax_element_BN), and 3) a third set of syntax elements (i.e., syntaxelem ent_C1, . . . syntax_element_CN). An extension of the first video codec specification may specify a second list of syntax element sets, wherein each syntax element set in the second list may or may not be present in the bitstream (hence, the indicator value also functions to inform the decoder which of the syntax element sets from the second list are in the bitstream). In the example above, the second list of syntax element sets could for instance include: 1) a fourth set of syntax elements (i.e., syntax_element_D1, . . . , syntax_element_DN) and 2) a fifth set of syntax elements (i.e., set syntax-element_E1, . . . , syntax_element_EN).

The embodiment thus provides a flexible extension mechanism where the number of possible future sets of syntax elements that may be indicated to be present in the bitstream based on the value of the indicator does not need to be defined in advance. The sets should be specified to be ordered in a bitstream such that sets included in the first video codec specification are decoded before any later specified sets. If a decoder is implemented according to the first video codec specification, it can then be able to decode the sets that were included in the video codec specification and ignore the data that follows the coded representation of the last decoded set that was specified in the first video codec specification.

Table 7 below illustrates an example use case, which is based on the NN post-filter characteristics SEI message in version 3 of the draft SEI specification, but additional parameters describing the complexity of the NN post-filter are signaled. The example contains syntax and semantics with additional text on top of version 3 of the draft SEI specification marked in bold in the syntax table. In the example below the indicator value is named “nnpfc_complexity_idc.”

TABLE 7

| | Descriptor |
|---|---|
| nn_post_filter_characteristics( payloadSize ) { | |
| ... | |
| nnpfc_complexity_idc | ue(v) |
| if( nnpfc_complexity_idc > 0 ) | |
| nnpfc_complexity_element( nnpfc_complexity_idc ) | |
| ... | |
| } | |
| ... | |
| } | |
| nnpfc_complexity_element( nnpfc_complexity_idc ) { | |
| if( (nnpfc_complexity_idc & 1) = = 1 ) { | |
| nnpfc_parameter_type_idc | u(2) |
| if (nnpfc_parameter_type_idc ! = 2) | |
| nnpfc_log2_parameter_bit_length_minus3 | u(2) |
| nnpfc_num_parameters_idc | u(6) |
| nnpfc_num_kmac_operations_idc | ue(v) |
| } | |
| if( (nnpfc_{—}complexity_{—}idc & 2) = = 2 ) { | |
| nnpfc_{—}total_{—}kilobyte_{—}size | ue(v) |
| } | |
| if( (nnpfc_{—}complexity_{—}idc & 4) = = 4 ) { | |
| nnpfc_{—}num_{—}layers | ue(v) |
| nnpfc_{—}architecture_{—}type_{—}idc | ue(v) |
| } | |
| } | |

nnpfc_complexity_idc greater than 0 specifies that one or more syntax elements that indicate the complexity of the post-processing filter associated with the nnpfc_id may be present. nnpfc_complexity_idc equal to 0 specifies that no syntax elements that indicate the complexity of the post-processing filter associated with the nnpfc_id are present. The value nnpfc_complexity_idc shall be in the range of 0 to 255, inclusive. Values of nnpfc_complexity_idc greater than 7 are reserved for future specification by ITU-T|ISO/IEC and shall not be present in bitstreams conforming to this version of this Specification. Decoders conforming to this version of this Specification shall ignore SEI messages that contain reserved values of nnpfc_complexity_idc.

nnpfc_total_kilobyte_size greater than 0 specifies the total size in kilobytes required to store the parameters for the neural network. nnpfc_total_kilobyte_size equal to 0 specifies that the total size required to store the parameters for the neural network is not specified. The value of nnpfc_total_kilobyte_size shall be in the range of 0 to 232−1, inclusive.

nnpfc_num_layers greater than 0 specifies the number of layers in the neural network. nnpfc_num_layers equal to 0 specifies that the number of layers in the neural network is not specified. The value of nnpfc_num_layers shall be in the range of 0 to 232−1, inclusive.

nnpfc_architecture_type_idc greater than 0 specifies the type of architecture used by the neural network as specified in table 8. The value nnpfc_architecture_type shall be in the range of 0 to 255, inclusive.

TABLE 8

| nnpfc_architecture_{—} | |
|---|---|
| type_idc | Architecture type |
| 0 | Not specified |
| 1 | Single-layer feed forward network |
| 2 | Multilayer feed forward network |
| 3 | Single node network with its own feedback |
| 4 | Single-layer recurrent network |
| 5 | Multilayer recurrent network |
| 6 . . . 255 | Reserved for future specification by |
| | ITU-T \| ISO/IEC |

In one embodiment, a decoder may perform all or a subset of the following steps, which are illustrated in FIG. 4:

(1) Deriving an indicator value (V) from one or more syntax elements in the bitstream encoded with VLC. For example, V may be derived from an indicator syntax element in a bitstream (e.g., V is decoded from the indicator syntax element), where V was encoded into the bitstream using variable length coding. In another example, V may be derived from multiple decoded syntax elements, wherein at least one of the multiple syntax elements is encoded with VLC.

(2) Determining whether V indicates that a first set of syntax elements are present in the bitstream, wherein the determining comprises determining whether (V & X) is equal to X, wherein & is a bitwise AND operator. In one version, X is equal to 2\hat{ }A where A is a non-negative integer (i.e., A is an integer ≥0). X may for instance be 1 (i.e., A may be 0). In one embodiment, if (V & X) is equal to X, then it is determined that the first set of syntax elements are present in the bitstream.

(3) If the first set of syntax elements is determined to be present in the bitstream, decoding a first set of values from the first set of syntax elements (i.e., decoding a first set of values from bits in the bitstream in accordance with the syntax of the first set of syntax elements).

(4) Determining whether V indicates that a second set of syntax elements is present in the bitstream, wherein the determining comprises determining whether (V & Y) is equal to Y, wherein & is a bitwise AND operator. In one version, Y is equal to 2\hat{ }B where B is a non-negative integer (i.e., B is an integer ≥0). Y may for instance be 2 (i.e., B may be 1). In one embodiment, if (V & Y) is equal to Y, then it is determined that the second set of syntax elements is present in the bitstream.

(5) If the second set of syntax elements is determined to be present in the bitstream, decoding a second set of values from the second set of syntax elements (i.e., decoding a second set of values from bits in the bitstream in accordance with the syntax of the second set of syntax elements).

(6) Determining whether V indicates that a third set of syntax elements are present in the bitstream, wherein the determining comprises determining whether (V & Z) is equal to Z, wherein & is a bitwise AND operator. In one version, Z is equal to 2\hat{ }C where C is a non-negative integer. Z may for instance be 4 (i.e., C may be 2). In one embodiment, if (V & Z) is equal to Z, then it is determined that the third set of syntax elements are present in the bitstream.

(7) If the third set of syntax elements is determined to be present in the bitstream, decoding a third set of values from the third set of syntax elements (i.e., decoding a third set of values from bits in the bitstream in accordance with the syntax of the third set of syntax elements).

(8) Processing at least one picture (e.g., process the picture using the first set of values, the second set of values, and/or the third set of values), wherein processing the picture comprises decoding the picture and/or post-filtering the picture. In a version of this embodiment where X is equal to 2\hat{ }A, Y is equal to 2\hat{ }B, and Z is equal to 2Ĉ, determining whether (V & k) is equal to k can be phrased as determining whether (V & k) is not equal to 0.

The indicator syntax element and/or the first and second set of syntax elements may be included i) in a parameter set (e.g., a DPS (a.k.a. DCI), VPS, SPS, PPS or APS), ii) in a header (e.g., slice header or picture header), or iii) in an SEI message. The post-filter may be an NN post filter, where the parameters for the post-filter may be carried in an SEI message.

In one embodiment, an encoder may perform all or a subset of the following steps to encode a picture to a bitstream.

(1) Determine whether a first set of syntax elements are present in the bitstream (or are to be added to the bitstream). The first set of syntax elements are associated with a first value, X.

(2) Determine whether a second set of syntax elements are present in the bitstream (or are to be added to the bitstream). The second set of syntax elements are associated with a second value, Y (Y≠X).

(3) Encode an indicator value V into a syntax element in the bitstream, wherein
i) (V & X) is equal to X, if the first set of syntax elements are to be added to the bitstream otherwise (V & X) is not equal to X (in one version, X is equal to 2\hat{ }A where A is a non-negative integer) and
ii) (V & Y) is equal to Y, if the second set of syntax elements are to be added to the bitstream, otherwise (V & Y) is not equal to Y (in one version, Y is equal to 2\hat{B} where B is a non-negative integer).

(4) In response to (V & X) being equal to X, encode the first set of syntax elements to the bitstream.

(5) In response to (V & Y) being equal to Y, encode the second set of syntax elements to the bitstream

(6) Encode the picture to the bitstream.

Optionally, encode the picture to the bitstream using the first set of syntax elements if (V & X) is equal to X, and the second set of syntax elements if (V & Y) is equal to Y. Optionally, a post-filter is applied after decoding the picture using the first set of syntax is elements if (V & X) is equal to X, and using the second set of syntax elements if (V & Y) is equal to Y.

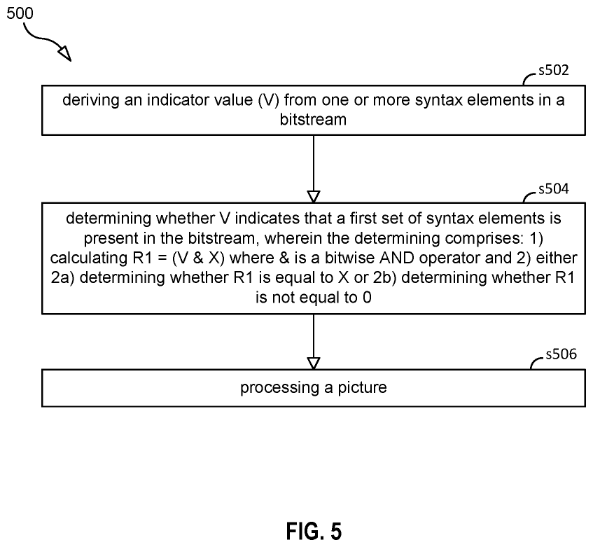

FIG. 5 is a flowchart illustrating a process 500 for picture processing. Process 500 may begin in step s502. Step s502 comprises deriving an indicator value (V) from one or more syntax elements in a bitstream (e.g., V may be decoded from a single indicator syntax element), where V was encoded into the bitstream using variable length coding. Step s504 comprises determining whether V indicates that a first set of syntax elements is present in the bitstream, wherein the determining comprises: 1) calculating R1=(V & X) where & is a bitwise AND operator and 2) either 2a) determining whether R1 is equal to X or 2b) determining whether R1 is not equal to 0. Step s506 comprises processing at least a first picture, wherein, if the first set of syntax elements are present in the bitstream, the first set of syntax elements are used in the processing of the first picture.

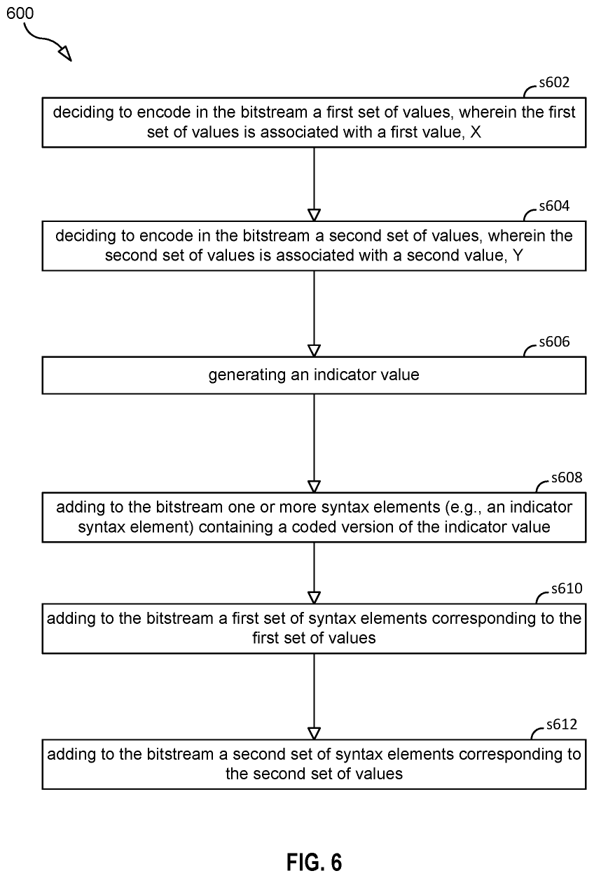

FIG. 6 is a flowchart illustrating a process 600 for creating a video bitstream. Process 600 may begin in step s602. Step s602 comprises deciding to encode in the bitstream a first set of values, wherein the first set of values is associated with a first value, X. Step s604 comprises deciding to encode in the bitstream a second set of values, wherein the second set of values is associated with a second value, Y. Step s606 comprises generating an indicator value, wherein generating the indicator value comprises generating the indicator value such that: (V & X) is equal to X, where V is the indicator value, and (V & Y) is equal to Y. Step s608 comprises adding to the bitstream one or more syntax elements (e.g., a single indicator syntax element) containing a coded version of the indicator value, wherein the indicator value was encoded using variable length coding. Step s610 comprises adding to the bitstream a first set of syntax elements corresponding to the first set of values. Step s612 comprises adding to the bitstream a second set of syntax elements corresponding to the second set of values.

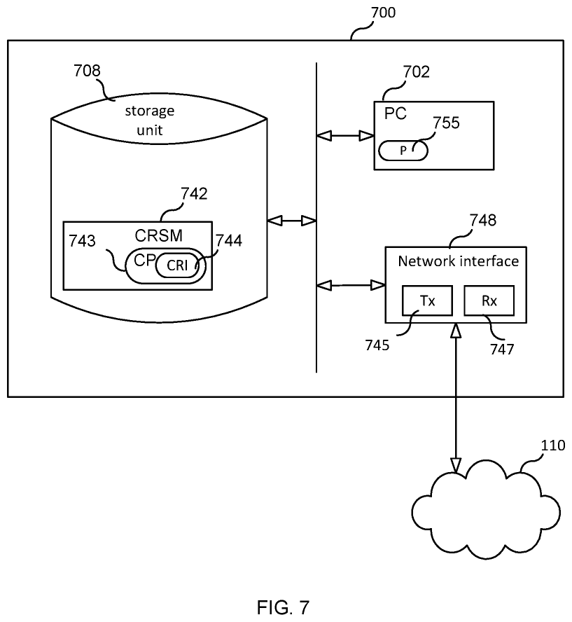

FIG. 7 is a block diagram of an apparatus 700 for implementing encoder 102 and/or decoder 104, according to some embodiments. When apparatus 700 implements encoder 102, apparatus 700 may be referred to as an encoder apparatus, and when apparatus 700 implements decoder 104, apparatus 700 may be referred to as a decoder apparatus. As shown in FIG. 7, apparatus 700 may comprise: processing circuitry (PC) 702, which may include one or more processors (P) 755 (e.g., one or more general purpose microprocessors and/or one or more other processors, such as an application specific integrated circuit (ASIC), is field-programmable gate arrays (FPGAs), and the like), which processors may be co-located in a single housing or in a single data center or may be geographically distributed (i.e., encoder apparatus 700 may be a distributed computing apparatus); at least one network interface 748 (e.g., a physical interface or air interface) comprising a transmitter (Tx) 745 and a receiver (Rx) 747 for enabling apparatus 700 to transmit data to and receive data from other nodes connected to a network 110 (e.g., an Internet Protocol (IP) network) to which network interface 748 is connected (physically or wirelessly) (e.g., network interface 748 may be coupled to an antenna arrangement comprising one or more antennas for enabling encoder apparatus 700 to wirelessly transmit/receive data); and a storage unit (a.k.a., “data storage system”) 708, which may include one or more non-volatile storage devices and/or one or more volatile storage devices. In embodiments where PC 702 includes a programmable processor, a computer readable storage medium (CRSM) 742 may be provided. CRSM 742 may store a computer program (CP) 743 comprising computer readable instructions (CRI) 744. CRSM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes encoder apparatus 700 to perform steps described herein (e.g., steps described herein with reference to the flow charts). In other embodiments, encoder apparatus 700 may be configured to perform steps described herein without the need for code. That is, for example, PC 702 may consist merely of one or more ASICs. Hence, the features of the embodiments described herein may be implemented in hardware and/or software.

### Summary of Various Embodiments

A1. A method (500) for picture processing, the method comprising: deriving an indicator value, V, from one or more syntax elements in a bitstream (e.g., V may be decoded from a single indicator syntax element), where V was encoded into the bitstream using variable length coding; determining whether V indicates that a first set of syntax elements is present in the bitstream, wherein the determining comprises: 1) calculating R1=(V & X) where & is a bitwise AND operator and 2) either 2a) determining whether R1 is equal to X or 2b) determining whether R1 is not equal to 0; and processing at least a first picture, wherein, if the first set of syntax elements is present in the bitstream, the first set of syntax elements is used in the processing of the first picture.

A2. The method of embodiment A1, further comprising: in response to determining that R1 is equal to X or R1 is not equal to 0, decoding a first set of values from the first set of syntax elements; and processing at least the first picture using the first set of values.

A3. The method of embodiment A1 or A2, further comprising: determining whether a second set of syntax elements is present in the bitstream, wherein the determining comprises: calculating R2=(V & Y) and either i) determining whether R2 is equal to Y or ii) determining whether R2 is not equal to 0

A4. The method of embodiment A3, further comprising: in response to determining that R2 is equal to Y or R2 is not equal to 0, decoding a second set of values from the second set of syntax elements; and processing the first picture and/or a second picture using the second set of values.

A5. The method of embodiment A3 when dependent on embodiment A2, further comprising: in response to determining that R2 is equal to Y or R2 is not equal to 0, decoding a second set of values from the second set of syntax elements; and processing the first picture and/or a second picture using both the first set of values and the second set of values.

A6. The method of A3, wherein the first set of syntax elements is present in the bitstream, the second set of syntax elements is also present in the bitstream following the first set of syntax elements (e.g. immediately following), and the method further comprises ignoring the second set of syntax elements.

A7. The method of embodiment A6, wherein processing the first picture comprises processing the first picture in accordance with a first version of a video codec specification, and the second set of syntax elements is specified in a second version of the video codec specification.

A8. The method of any one of embodiments A3-A7, wherein X=2\hat{ }A, where A is an integer greater than or equal to 0, Y=2\hat{ }B, where B is an integer greater than or equal to 0, and B≠A.

A9. The method of any one of embodiments A3-A8, wherein X=1, and Y=2.

A10. The method of any one of embodiments A1-A9, wherein deriving the indicator value V from the one or more syntax elements comprises decoding the indicator value V from the one or more syntax elements, and at least one of the one or more syntax element was encoded using universal variable length coding, UVLC.

A11. The method of any one of embodiments A1-A10, wherein the bitstream comprises a parameter set and the parameter set comprises the one or more syntax elements, the bitstream comprises a header and the header comprises the one or more syntax elements, or the bitstream comprises an SEI message and the SEI message comprises the one or more syntax elements.

A12. The method of any one of embodiments A1-A11, wherein processing the first picture comprises post-filtering the first picture using a neural network, NN, post-filter.

A13. The method of any one of embodiments A3-A12, wherein the indicator value and the first set of syntax elements are defined in a first video codec specification, and the second set of syntax elements is defined in an updated version of the video codec specification but not defined in the first video codec specification.

A14. The method of any one of embodiments A1-A13, wherein processing the first picture comprises: decoding the first picture; and/or post-filtering the first picture.

A15. The method of any one of embodiment A1-A14, wherein the one or more syntax elements in the bitstream consist of a single indicator syntax element, and deriving the indicator value V from the indicator syntax element comprises decoding the indicator value V from the indicator syntax element which was encoded using universal variable length coding, UVLC.

A16. The method of any one of claims A1-A15, wherein the one or more syntax elements in the bitstream consist of a single indicator syntax element, and the bitstream comprises a parameter set and the parameter set comprises the indicator syntax element, the bitstream comprises a header and the header comprises the indicator syntax element, or the bitstream comprises an SEI message and the SEI message comprises the indicator syntax element.

B1. A method (600) for creating a video bitstream, the method comprising: deciding to encode in the bitstream a first set of values, wherein the first set of values is associated with a first value, X; deciding to encode in the bitstream a second set of values, wherein the second set of values is associated with a second value, Y; generating an indicator value; adding to the bitstream one or more syntax elements (e.g., a single indicator syntax element) containing a coded version of the indicator value, wherein the indicator value was encoded using variable length coding; adding to the bitstream a first set of syntax elements corresponding to the first set of values; and adding to the bitstream a second set of syntax elements corresponding to the second set of values, wherein generating the indicator value comprises generating the indicator value such that: (V & X) is equal to X, where V is the indicator value, and (V & Y) is equal to Y.

B2. The method of embodiment B1, wherein X=2\hat{ }A, where A is an integer greater than or equal to 0, Y=2\hat{ }B, where B is an integer greater than or equal to 0, and B≠A.

B3. The method of embodiment B1 or B2, wherein X=1, and Y=2.

B4. The method of any one of embodiments B1-B3, wherein the indicator value was encoded using universal variable length coding.

B5. The method of any one of embodiments B1-B4, wherein the bitstream comprises a parameter set and the parameter set comprises the one or more syntax elements, the bitstream comprises a header and the header comprises the one or more syntax elements, or the bitstream comprises an SEI message and the SEI message comprises the one or more syntax elements.

C1. A computer program (743) comprising instructions (744) which when executed by processing circuitry (702) of an apparatus (700) causes the apparatus to perform the method of any one of the above embodiments.

C2. A carrier containing the computer program of embodiment C1, wherein the carrier is one of an electronic signal, an optical signal, a radio signal, and a computer readable storage medium (742).

D1. An apparatus (700) configured to perform the method of any one of embodiments A1-A16 or B1-B5.

While the terminology in this disclosure is described in terms of VVC, the embodiments of this disclosure also apply to any existing or future codec, which may use a different, but equivalent terminology.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for picture processing, the method comprising:
deriving an indicator value, V, from one or more syntax elements in a bitstream, where V was encoded into the bitstream using variable length coding;
determining whether V indicates that a first set of syntax elements is present in the bitstream, wherein the determining comprises: calculating R1=(V & X) where & is a bitwise AND operator and either determining whether R1 is equal to X or determining whether R1 is not equal to 0;
determining whether a second set of syntax elements is present in the bitstream by calculating R2=(V & Y) and either i) determining whether R2 is equal to Y or ii) determining whether R2 is not equal to 0; and
in response to determining that R2 is equal to Y or R2 is not equal to 0:
decoding a second set of values from the second set of syntax elements; and
processing the first picture and/or a second picture using the second set of values, wherein
X=2\hat{ }A, where A is an integer greater than or equal to 0,
Y=2\hat{ }B, where B is an integer greater than or equal to 0, and
B≠A.

2. The method of claim 1, wherein the method further comprises, in response to determining that R1 is equal to X or R1 is not equal to 0:
decoding a first set of values from the first set of syntax elements; and
processing at least the first picture using the first set of values.

3-4. (canceled)

5. The method of claim 2, further comprising:
in response to determining that R2 is equal to Y or R2 is not equal to 0, decoding a second set of values from the second set of syntax elements; and
processing the first picture and/or a second picture using both the first set of values and the second set of values.

6. The method of claim 1, wherein
the first set of syntax elements is present in the bitstream,
the second set of syntax elements is also present in the bitstream following the first set of syntax elements, and
the method further comprises ignoring the second set of syntax elements.

7. The method of claim 6, wherein
processing the first picture comprises processing the first picture in accordance with a first version of a video codec specification, and
the second set of syntax elements is specified in a second version of the video codec specification.

8. (canceled)

9. The method of claim 1, wherein
X=1, and
Y=2.

10. The method of claim 1, wherein
deriving the indicator value V from the one or more syntax elements comprises decoding the indicator value V from the one or more syntax elements, and
at least one of the one or more syntax element was encoded using universal variable length coding.

11. The method of claim 1, wherein
the bitstream comprises a parameter set and the parameter set comprises the one or more syntax elements,
the bitstream comprises a header and the header comprises the one or more syntax elements, or
the bitstream comprises an SEI message and the SEI message comprises the one or more syntax elements.

12. The method of claim 1, wherein processing the first picture comprises post-filtering the first picture using a neural network (NN) post-filter.

13. The method of claim 1, wherein
the indicator value and the first set of syntax elements are defined in a first video codec specification, and
the second set of syntax elements is defined in an updated version of the video codec specification but not defined in the first video codec specification.

14. The method of claim 1, wherein processing the first picture comprises:
decoding the first picture; and/or
post-filtering the first picture.

15. A method for creating a bitstream, the method comprising:
deciding to encode in the bitstream a first set of values, wherein the first set of values is associated with a first value, X;
deciding to encode in the bitstream a second set of values, wherein the second set of values is associated with a second value, Y;
generating an indicator value;
adding to the bitstream one or more syntax elements containing a coded version of the indicator value, wherein the indicator value was encoded using variable length coding;
adding to the bitstream a first set of syntax elements corresponding to the first set of values; and
adding to the bitstream a second set of syntax elements corresponding to the second set of values, wherein
generating the indicator value comprises generating the indicator value such that:
(V & X) is equal to X, where V is the indicator value, and
(V & Y) is equal to Y, wherein
X=2\hat{ }A, where A is an integer greater than or equal to 0,
Y=2\hat{ }B, where B is an integer greater than or equal to 0, and
B≠A.

16. (canceled)

17. The method of claim 15, wherein
X=1, and
Y=2.

18. The method of claim 15, wherein the indicator value was encoded using universal variable length coding.

19. The method of claim 15, wherein
the bitstream comprises a parameter set and the parameter set comprises the one or more syntax elements,
the bitstream comprises a header and the header comprises the one or more syntax elements, or
the bitstream comprises a supplemental enhancement information (SEI) message and the SEI message comprises the one or more syntax elements.

20. A non-transitory computer readable storage medium storing a computer program comprising instructions which when executed by processing circuitry of an apparatus causes the apparatus to perform the method of claim 1.

21-26. (canceled)

27. An apparatus, the apparatus comprising:
memory; and
processing circuitry, wherein the apparatus is configured to perform a method comprising:
deriving an indicator value, V, from one or more syntax elements in a bitstream, where V was encoded into the bitstream using variable length coding;
determining whether V indicates that a first set of syntax elements is present in the bitstream, wherein the determining comprises: calculating R1=(V & X) where & is a bitwise AND operator and either determining whether R1 is equal to X or determining whether R1 is not equal to 0;
determining whether a second set of syntax elements is present in the bitstream by calculating R2=(V & Y) and either i) determining whether R2 is equal to Y or ii) determining whether R2 is not equal to 0; and
in response to determining that R2 is equal to Y or R2 is not equal to 0:
decoding a second set of values from the second set of syntax elements; and
processing the first picture and/or a second picture using the second set of values,
wherein
X=2\hat{ }A, where A is an integer greater than or equal to 0,
Y=2\hat{ }B, where B is an integer greater than or equal to 0, and
B≠A.

28. The apparatus of claim 27, wherein the one or more syntax elements consists of a single indicator syntax element.

29. An apparatus, the apparatus comprising:
memory; and
processing circuitry, wherein the apparatus is configured to perform a method for creating a bitstream, the method comprising:
deciding to encode in the bitstream a first set of values, wherein the first set of values is associated with a first value, X;
deciding to encode in the bitstream a second set of values, wherein the second set of values is associated with a second value, Y;
generating an indicator value;
adding to the bitstream one or more syntax elements containing a coded version of the indicator value, wherein the indicator value was encoded using variable length coding;
adding to the bitstream a first set of syntax elements corresponding to the first set of values; and
adding to the bitstream a second set of syntax elements corresponding to the second set of values, wherein
generating the indicator value comprises generating the indicator value such that:
(V & X) is equal to X, where V is the indicator value, and
(V & Y) is equal to Y, wherein
X=2\hat{ }A, where A is an integer greater than or equal to 0,
Y=2\hat{ }B, where B is an integer greater than or equal to 0, and
B≠A.
